(19) United States
(12) Patent Application Publication
(10) Pub. No.: US 2011/0311741 A1
(43) Pub. Date: Dec. 22, 2011

(54) SINGLE-LAYER OR MULTILAYER TUBULAR FOOD PACKAGING FILM THAT CAN BE SMOKED, AIR-DRIED, AND PEELED, ESPECIALLY PEELED IN A FULLY AUTOMATIC MANNER, AND METHOD FOR THE PRODUCTION THEREOF

(75) Inventor: Jurgen Schiffmann, Hennef (DE)

(73) Assignee: KUNE ANLAGENBAU GMBH, St. Augustin//Menden (DE)

(21) Appl. No.: 13/201,205

(22) PCT Filed: Oct. 27, 2009
(86) PCT No.: PCT/EP09/07683

§ 371 Date: Sep. 9, 2011

(30) Foreign Application Priority Data
Feb. 20, 2009 (DE) 10 2009 009 859.3

(51) Int. Cl. A22C 13/00; C08L 53/00; C08L 29/04

(52) U.S. Cl. 428/34.8; 264/565; 525/57; 525/92 A

(57) ABSTRACT

The present invention relates to a single-layer or multilayer tubular food packaging film that can be smoked, air-dried and peeled, in particular peeled in a fully automated manner, in particular a sausage casing, for smoked and/or air-dried sausage or meat goods, wherein the polymer-based food film is manufactured of a homogeneous molten plastic material in a (co-)extrusion film blow molding plant by means of (co-)extruded plastics supplied to a nozzle of a blow head and biaxially stretched in the triple-bubble process, the homogeneous molten plastic material being produced of a plastic blend of PS or a blend of various PSs and PVOHs and/or PEBAs. The present invention moreover relates to a method for the manufacture of the food film.

The present invention relates to a single-layer or multilayer tubular food packaging film that can be smoked, air-dried and peeled, in particular peeled in a fully automated manner, in particular a sausage casing for smoked and/or air-dried sausage or meat goods, wherein the polymer-based food film is manufactured of a homogeneous molten plastic material in a (co-)extrusion film blow molding plant by means of (co-)extruded plastics supplied to a nozzle of a blow head and biaxially stretched in the triple-bubble process, in accordance with the preamble of claim 1. The invention further relates to a method for the manufacture thereof in accordance with the preamble of claim 12.

Smokeable sausage casings are known from practice and from literature. Thus patent specification DE 199 42 835 A1 discloses a sausage casing of an artificial sausage casing material, for which purpose a gas and oxygen permeable, soft plastic material is employed. The sausage casing material described in DE 199 42 835 A1 has an irregularly curved sausage shape with welded longitudinal seams. This sausage casing is said to be smokeable and have a sufficiently high strength.

From patent specification DE 198 30 389 A1 there is furthermore known a film for foodstuffs that can be air-dried and smoked.

Patent specification DE 101 25 762 A1 moreover discloses a shaped article having an irregular outer contour which is produced from a once-folded web of film material of a weldable plastic in a welding and cutting machine for welding and cutting the material webs. This cut-welded shaped article is said to provide a smokeable sausage casing having a sufficiently high strength.

From patent specification DE 35 26 394 C2 a raw sausage casing is moreover known which is said to be produced of a binder-free spun fleece of at least one polyamide (in brief: PA) joined together into a hose in the longitudinal direction. This raw sausage casing is said to be smokeable.

Patent specification DE 35 26 394 C2 also makes reference to document DE 30 29 028 A1 which discloses a fiber fleece-reinforced artificial casing which is said to be smokeable. The fiber fleece used for this purpose may be formed on the basis of PA. Particularly suited spun fleeces are to be on the basis of PA and polypropylene (in brief: PP). The like spun fleeces are to be impregnated with a coating solution. Suitable coating materials in accordance with patent specification DE 30 29 028 A1 are, in turn, any film-forming polymers that may be applied in the form of a powder and subsequently thermally melted into a film. Suitable film-forming polymers furthermore are those which may be applied as a coating in the form of a molten mass, solution, suspension or dispersion and formed into a film by subsequent drying. Suitable coating materials mentioned are, i. a., molecular disperse or colloidal solutions or suspensions of various polymers or blends thereof such as, e.g., polyvinyl alcohol (in brief: PVOH).

Document DE 42 20 957 A1 discloses a packaging casing comprising a flexible carrier material provided with a foam layer. The coating material used for this purpose is to be fully saponified PVOH. The foam of this substance is said to be waterproof, grease-tight and substantially impermeable to oxygen, nitrogen and carbon dioxide. Merely water vapor may penetrate freely through the foam layer of fully saponified PVOH. Fully saponified PVOH is therefore said to be suited for sausage casings and in particular for raw sausages. Combinations of PVOH with other plastic dispersions are furthermore said to be conceivable.

On the other hand, document WO 00/75220 A1 discloses a film casing on the basis of an extruded, tubular blend of plastics consisting of PA and polyether block amide (in brief: PEBA). In theory, the blend mentioned does result in a higher water vapor and oxygen permeability or permeation as compared with traditional PA blends, and thus also in a limited smokeability. But in practice the desired and necessary surface dyeing of the sausage or meat goods is lacking entirely.

According to the applicant's practical experience, smokeability is highly dependent on the PEBA content which is, however, not sufficient even at high PEBA concentrations. It is a further drawback that PEBA is a costly and soft material. As a result, blends having a correspondingly high PEBA content do admit a certain degree of smokeability. On the one hand, however, owing to the high costs and particularly owing to the much too low rigidity and strength, gathering of the film which is required particularly for sausage goods is rendered difficult or even impossible. On the other hand, the poor dimensional stability forbids a use of this film casing for raw sausage or hard sausage and in particular for salami. In addition, the low peelability of this film casing forbids its use for boiled sausage such as, e.g., hot dogs.

Patent specification DE 102 95 683 T5 in contrast discloses a sausage casing of a blend of PA and a low proportion of PVOH. Other than the film casing in accordance with document WO 00/75220 A1, this blend permits a certain, albeit non-optimum, surface dyeing of the sausage or meat goods. The required oxygen or gas permeability is, however, clearly too low. The water vapor permeability is higher as compared with PA or PA/PEBA blends, yet too low for a use as a smokeable food film. With this film structure, an improvement of surface dyeing and of the permeability to oxygen or water vapor and thus of smokeability might only be achieved by drastically reducing the wall thickness. This would in turn, however, in a same degree have a negative effect on the rigidity and/or strength and thus on the gathering suitability, which is contrary to a use for raw or hard sausage. A use for boiled sausage such as, e.g., hot dogs is not possible due to the insufficient peelability.

Documents DE 103 02 960 A1, DE 103 20 327 A1 and DE 103 23 417 B3 finally disclose food casings which are equally based on PA. With the aim of improving smokeability, a plurality of additional components such as PVOH and PEBA are here partly admixed to the the base material PA. The resulting blend provides limited usefulness with regard to surface dyeing, oxygen and water vapor permeability for several applications in the sausage field. One drawback of this film structure, however, is the lack of rigidity and strength, for in this case no less than two soft components (PVOH, PEBA) are admixed to the relatively rigid base material PA in order to obtain smokeability and surface dyeing. Even an admixture of small quantities of the two additional components reduces the rigidity and/or strength of the film to a level that is too low for most applications. In addition, a higher admixture of the additional components or a reduction in wall thickness would be necessary in order to improve the insufficient smokeability and surface dyeing. This in turn negatively influences the gathering suitability as well as the strength that is required for most uses.

It is thus true that smokeable food casings on a polymer basis and particularly on the basis of PA with PVOH and PEBA are thus known from the prior art, however their low rigidity and thus poor gathering suitability, as well as a dimensional stability that is not satisfactory as a general rule, only allow for a limited range of use. In addition, the permeability to, and absorption of, water vapor that are too low for smoke absorption, and the excessively high level of costs on account of the relatively high price for PA and the higher material thickness required for the rigidity are only conditionally suitable for the intended purposes of use.

From the prior art the utilization of nettings, flexible carrier materials or spun fleeces is furthermore known in order to improve the mechanical properties of food films in large-series manufacture. However, particularly in the case of fiber fleeces or spun fleeces, these frequently have to be condensed or coated to thereby increase complexity. Their low rigidity can, however, not be increased sufficiently in this way, so that gathering is made much more difficult and gathering of small calibers without a netting in particular is rendered plainly impossible. Such known sausage casings accordingly have not been suited for automated further processing up to the present date.

In addition the above-described food casings exhibit an excessively high adherence of stuffing as well as a clearly insufficient tearing and/or splicing tendency in the machine direction and/or in the longitudinal direction of the sausage. This results in insufficiency or total lack of peelability, in particular when support nettings, fibers or spun fleeces are used.

It is therefore an object of the present invention to propose a single-layer or multilayer tubular food packaging film that can be smoked, air-dryed and peeled, in particular peeled in a fully automated manner, which may be produced in large quantities and in a cost-efficient manner from a molten plastic material in industrial mass production, wherein the food film achieves the core parameters such as smokeability—which is determined by the oxygen and water vapor permeability and by the oxygen and water vapor absorption—, surface dyeing of the stuffing, rigidity and/or strength (dimensional stability) and in particular peelability, which may subsequently be processed further in an automated manner and and peeled in a fully automated manner. It is a further object to specify a method appropriate for this purpose.

This object is achieved through the features of claim 1, and in terms of process technology through the features of claim 12.

What is being proposed in accordance with the invention is a single-layer or multilayer smokeable, air-dryable, peelable, in particular fully automatically peelable, tubular food film, in particular a sausage casing for smoked and/or air-dried sausage or meat goods, wherein the polymer-based food film is manufactured of a homogeneous molten plastic material in a (co-) extrusion film blow molding plant by means of (co-)extruded plastics supplied to a nozzle of a blow head and biaxially stretched in the triple-bubble process. This homogeneous molten plastic material is produced of a plastic blend of polystyrene (in brief: PS) or of a blend of various PSs and PVOHs and/or PEBAs.

Advantageously this not only for the first time allows the large-scale manufacture of smokeable, air-dryable, peelable, in particular fully automatically peelable, tubular food films for food packagings in the nozzle blast drawing process and subsequent biaxial stretching in the triple-bubble process, but it is possible to entirely do away with the nettings, flexible carrier materials or spun fleeces discussed in the foregoing, which are felt to be a particular disadvantage in large-series production. The food film of the invention thus for the first time provides a peelable food film that had hitherto not been available, and a food film that may be peeled in a fully automated manner, that had hitherto not been available at all.

In a particularly advantageous manner it is additionally possible to substitute the known PA blends which have found only conditional use in the market because of their insufficient permeability and absorption values and because of their insufficient rigidity and their excessively high costs.

Various studies and tests involving the food film of the invention revealed several trends. Thus, a high PS content is essentially necessary for a good dimensional stability and rigidity. Other than PA-based blends, the high PS content does not detract from the desired high smoke permeability, surface dyeing of the stuffing, and the low adherence of stuffing. Namely, the smoke permeability paralleling the water vapor absorption and permeability as well as the surface dyeing are reduced clearly less by a high PET content than by similar PA composites. In addition, a high PS content causes the food casing to have virtually no adherence of stuffing.

It was moreover found that the water vapor and smoke permeability may be improved substantially and at the same time the peelability may be optimized further by the addition of PEBA. The addition of PEBA does, however, not yet permit a final adjustment of the desired high oxygen or water vapor permeability and thus of the smoke permeability. Neither can surface dyeing be adjusted in a satisfactory manner solely by the addition of PEBA. In addition, dimensional stability and/or rigidity are degraded by an inappropriately apportioned addition of PEBA, resulting in a further tradeoff with regard to desired properties.

It was, however, surprisingly found that the further admixture of PVOH for the first time resulted in a plastic blend which exhibits the desired high water vapor permeability and thus also smoke permeability if the blend proportions are selected and apportioned in accordance with the invention. Moreover high surface dyeing and a substantially higher rigidity are hereby attained. In addition the adherence of stuffing is reduced further. Adjustability of the dimensional stability moreover remains optimum with the plastic blend of the invention.

The smokeable, air-dryable, peelable, in particular fully automatically peelable, tubular food film of the invention is particularly well suited for boiled sausages such as, e.g., hot dogs. It furthermore maintains contact with the stuffing without forming wrinkles even if the stuffing was filled in manually, i.e., without pressure or under only low pressure and without the use of appropriate filling machines.

Meat or sausage goods produced with the smokeable, air-dryable, peelable, in particular fully automatically peelable, tubular food film of the invention for food packagings such as, e.g., boiled sausages and in particular hot dogs, are excellently suited for smoking and particularly well suited for air-drying. They are moreover excellently suited for manual or automated peeling.

Advantageous developments of food film of the invention are subject matter of the subclaims.

Thus, in a first variant the plastic blend of the single-layer or multilayer smokeable, air-dryable, peelable, in particular fully automatically peelable, tubular food film may include
a proportion of PS or of a blend of various PSs from 50 to 99% (wt.), and
a proportion of PVOH from 1 to 50% (wt.);
   or in a second variant may include
a proportion of PS or a blend of various PSs from 70 to 99% (wt.), and
a proportion of PEBA from 1 to 30% (wt.);
   or in a third variant may include
a proportion of PS or a blend of various PSs from 20 to 98% (wt.),
a proportion of PVOH from 1 to 50% (wt.), and
a proportion of PEBA from 1 to 30% (wt.).

In a particularly advantageous embodiment, the plastic blend of the third variant includes
a proportion of PS or a blend of various PSs from 55 to 90% (wt.), in particular from 60 to 75% (wt.),
a proportion of PVOH from 5 to 30% (wt.), in particular from 15 to 25% (wt.), and
a proportion of PEBA from 1 to 15% (wt.), in particular from 5 to 10% (wt.).

These embodiments of the invention for the first time permit a particularly simple manufacture of a smokeable, air-dryable, peelable, in particular fully automatically peelable, tubular food film in the nozzle blast drawing process with subsequent biaxial stretching in the triple-bubble process, which thus for the first time fully accommodates the requirements of a smokeable, peelable, in particular fully automatically peelable sausage casing, for example for hot dogs and the like. This food film, i.e., this sausage casing or food film, achieves maximum water vapor absorption and smoke permeability, wherein apart from the oxygen permeability the water vapor permeability and absorption are also of importance for the smoking process. Concurrently a high rigidity is obtained which is crucial for a good gathering process. The good dimensional stability demanded for an optimum filling process is equally attained with this food film.

In addition the demanded, particularly low adherence of stuffing and the extraordinarily good peelability which have a bearing on the later processing operations are readily obtained with the food film of the invention, for the base raw material PS—other than PA-based blends—practically does not enter into any adherence with the stuffing.

Finally, the desired high surface dyeing of the stuffing, in particular of the sausage goods, which makes for the typical optical appearance of smoked sausage goods, is also excellently obtained with the food film of the invention.

Moreover the food film may exhibit a film thickness in a range from 10 to 50 μm, preferably from 15 to 25 μm, preferably at a caliber of up to 90 mm, in particular at a caliber in a range from 15 to 40 mm. It is thus possible to select a film thickness providing a sufficiently high strength and dimensional stability for the food casing of the invention.

In another embodiment the food film may exhibit a water vapor permeability of at least 0.5 kg/(m²·day), preferably in a range from 0.5 to 0.75 kg/(m²·day), at a film thickness of 20 μm (measurement method: ISO 15106-1).

The food film may moreover exhibit an oxygen permeability of at least 4,000 cm³/(m²·day), preferably in a range from 4,000 to 6,000 cm³/(m²·day) (measurement method: ISO 15105-1).

Thus, although PA-based blends exhibit a slightly higher water vapor permeability in a range from 0.8 kg/(m²·day) to 1.0 kg/(m²·day), their oxygen permeability of 100 to 200 cm³/m² is many times lower than that of the food film of the invention.

The extraordinarily high oxygen permeability of the food film of the invention, which is up to 50 times higher than that of comparable PA blends, allows for the realization of even extremely small film thicknesses at a concurrently high rigidity. Thus, it is for the first time possible to manufacture a particularly thin film, which constitutes an advantage for the subsequent smoking and optional air-drying, but at any rate for the fully automated peeling process, in particular for boiled sausage or hot dogs.

It is furthermore advantageous if the food film exhibits a modulus of elasticity of at least 3,000 N/mm², preferably in a range from 3,000 to 3,600 N/mm² (measurement method: ISO 527). In comparison, PA-based blends exhibit a modulus of elasticity of only 400 to 750 N/mm² (measurement method: ISO 527). At the same time, the rigidity is a measure of an excellent strength of the food film which is four to nine times as high as that of the traditional, PA-based blends. It is thus possible to realize particularly small wall thicknesses of the food film of the invention. This in turn brings about the advantages not only of good smokeability but also an optimum capability of automated further processing of the food film.

In addition the costs of PA-based blends are at least 30 to 50% higher than those of comparable PS blends.

At the same time the food film of the invention exhibits a preferably automated peelability at a velocity of at least 0.4 m/s to at least 1.0 m/s or more than 1.2 m/s, in particular of at least 0.5 m/s to at least 0.7 m/s. This extraordinarily good peelability allows fully automated peeling of at least 200 pieces of boiled sausage or hot dogs per minute, which is due to the extraordinary tearing and splicing tendency of the food film. In addition the food film exhibits a very good dimensional stability, so that meat or sausage goods produced with it maintain a desired shape predetermined by the sausage casing particularly well after corresponding smoking steps and in a given case also after prolonged air-drying phases.

Accordingly, the food film of the invention is characterized by a particularly good gathering suitability allowing even for small calibers having a diameter of less than 30 mm, a ratio of extended length to gathered length of at least 100 m in the extended condition and 20 cm in the gathered condition

In another embodiment the plastic blend may include at least one silicate. Hereby the water vapor and smoke permeability is increased considerably.

In addition the plastic blend may include at least one filler selected from a group consisting of corn starch, cellulose powder and micro glass beads. The addition of such a filler also results in a considerable increase in water vapor and smoke permeability.

In addition the plastic blend may include at least one filler selected from a group consisting of chalk, talcum, salts and other mineral substances. Such an addition brings about an improvement of the permeability and absorption properties.

In terms of process technology, the object discussed in the foregoing is attained through the features of claim 12, with the above-discussed features and advantages applying analogously to the method of the invention.

Thus, in the method of the invention for the manufacture of a single-layer or multilayer smokeable, air-dryable and peelable, in particular fully automatically peelable, tubular food film, in particular a sausage casing for smoked and/or air-dried sausage or meat goods, the sausage or meat goods are filled into the food film prior to smoking and/or air-drying. This food film is manufactured of a homogeneous molten plastic material in the nozzle blast drawing process and under subsequent biaxial stretching in the triple-bubble process. The molten plastic material is furthermore produced of PS or a blend of various PSs and PVOHs and/or PEBAs.

Advantageous developments of the method of the invention are subject matter of the subclaims, with all of the advantages mentioned for the food casing of the invention as discussed in the foregoing being analogously valid for the method of the invention.

Thus, a first, second or third variant of the plastic blend may be selected, wherein the first variant includes
a proportion of PS or a blend of various PSs from 50 to 99% (wt.), and
a proportion of PVOH from 1 to 50% (wt.);
   the second variant includes
a proportion of PS or a blend of various PSs from 70 to 99% (wt.), and
a proportion of PEBA from 1 to 30% (wt.),
   or the third variant includes
a proportion of PS or a blend of various PSs from 20 to 98% (wt.),
a proportion of PVOH from 1 to 50% (wt.), and
a proportion of PEBA from 1 to 30% (wt.).

In a particularly advantageous embodiment of the method it is possible to supply, in order to manufacture the food film according to the third variant,
a proportion of PS or a blend of various PSs from 55 to 90% (wt.), in particular from 60 to 75% (wt.),
a proportion of PVOH from 5 to 30% (wt.), in particular from 15 to 25% (wt.), and
a proportion of PEBA from 1 to 15% (wt.), in particular from 5 to 10% (wt.).

Thus, a film thickness of the food film may be adjusted in a range from 10 to 50 μm, preferably from 15 to 25 μm, preferably at a caliber of up to 90 mm, in particular at a caliber in a range from 15 to 40 mm.

Furthermore the plastic blend may be selected such that the food film exhibits a water vapor permeability of at least 0.5 kg/(m²·day), preferably in a range from 0.5 to 0.75 kg/(m²·day), at a film thickness of 20 μm.

In addition the plastic blend may be selected such that the food film exhibits an oxygen permeability of at least 4,000 cm³/(m²·day), preferably in a range from 4,000 to 6,000 cm³/(m²·day).

In another embodiment the plastic blend may be selected such that the food film exhibits a modulus of elasticity of at least 3,000 N/mm², preferably in a range from 3,000 to 3,600 N/mm².

The plastic blend may furthermore be selected such that the food film is peelable at a velocity of at least 0.4 m/s to at least 1.0 m/s or more than 1.2 m/s, in particular of at least 0.5 m/s to at least 0.7 m/s, preferably in an automated manner.

In addition at least one silicate may be added to the plastic blend.

It is furthermore possible to add at least one filler selected from a group consisting of corn starch, cellulose powder and micro glass beads to the plastic blend.

Finally it is possible to add at least one filler selected from a group consisting of chalk, talcum, salts and other mineral substances to the plastic blend.

The preferred plastic blends described in the foregoing and further plastic blends were subjected to a number of studies and test series at the applicant's facilities in order to determine the optimum plastic blends for the manufacture of the smokeable, air-dryable, peelable, in particular fully automatically peelable, tubular food film of the invention for food packagings such as, e.g., sausage casings. To this end, suitable plastic blends were used to produce molten plastic materials, from which the food films were in turn manufactured in the nozzle blast drawing process. Subsequently the films were biaxially stretched in the triple-bubble process. Finally, the films manufactured and stretched in this way were examined with regard to the above-described properties.

In a preferred practical example of the smokeable, air-dryable food packaging film, the proportion of PS preferably is 50 to 90% (wt.). The proportion of PVOH is between 10 and 30% (wt.), preferably between 15 to 25% (wt.). Accordingly in a given case a proportion of PEBA is 1 to 15% (wt.), preferably 5 to 10% (wt.). The mixing ratios thereby specified result in a particularly good food film for sausage casing and in particular peelable casings.

The casing or film of the invention may be formed to be single- or multilayered.

It is moreover provided that natural smoke, liquid smoke or any other conceivable application form of smoke or smoke substitute substances is usable for smoking.

The aspects and advantages of the present invention discussed in the foregoing may best be obtained by making use of further synergy effects on an apparatus or system by the same applicant for the manufacture of peelable, tubular food films for food packagings such as, e.g., sausage casings, in the nozzle blast drawing process if the system for rapid cooling of thin thermoplastic tubes following their extrusion as disclosed in the patent specification DE 199 16 428 B4 to the same applicant is utilized additionally. In this regard it is also possible to consider a corresponding further development in accordance with patent specification DE 100 48 178 B4.

In this event the tubular film produced of the molten plastic material in the nozzle blow head is subjected to intense cooling in which the amorphous structure of the thermoplastic materials from the molten plastic material is preserved. The tubular film vertically extruded in the nozzle blow head from the molten plastic material initially travels into the cooling apparatus for being cooled without contacting the wall, as is described in detail in the patent specifications DE 199 16 428 B4 and DE 100 48 178 B4. With regard to details of the techniques and to the construction and the operation of this cooling means also referred to as a calibration means, the contents of DE 199 16 428 B4 and DE 100 48 178 B4 are hereby fully incorporated by way of reference in order to avoid repetitions.

In the cooling means, the tubular film then passes through support elements against which the film is supported due to a differential pressure between the inside of the tubular film and the cooling medium, wherein a liquid film is preserved between film and support elements to thereby preclude adhesion of the tubular film. The diameter of the support elements has a bearing on the diameter of the tubular film, which is the reason why this cooling means by the same applicant is also referred to as a calibrating means.

The above-discussed aspects and advantages of the plastic blend of PET with PVAL and/or PEBA may best be attained in combination with the nozzle blast drawing process and the subsequent rapid, intense cooling with the aid of the presently discussed calibrating means.

1. A single-layer or multilayer tubular food film that can be smoked, air-dried, and peeled, wherein the food film is manufactured of a homogeneous molten plastic material in a (co-)extrusion film blow molding plant by means of (co-)extruded plastics supplied to a nozzle of a blow head and biaxially stretched in the triple-bubble process,
wherein
the homogeneous molten plastic material is produced of a plastic blend of
polystyrene or a blend of various polystyrenes, and
polyvinyl alcohol, and/or
polyether block amide.

2. The single-layer or multilayer tubular food film that can be smoked, air-dried and peeled of claim 1, wherein the plastic blend includes
a proportion of polystyrene or a blend of various polystyrenes from 20 to 98% (wt.),
a proportion of polyvinyl alcohol from 1 to 50% (wt.), and
a proportion of polyether block amide from 1 to 30% (wt.).

3. The single-layer or multilayer tubular food film that can be smoked, air-dried and peeled of claim 2, wherein the plastic blend includes
a proportion of polystyrene or a blend of various polystyrenes from 55 to 90% (wt.), in particular from 60 to 75% (wt.),
a proportion of polyvinyl alcohol from 5 to 30% (wt.), in particular from 15 to 25% (wt.), and
a proportion of polyether block amide from 1 to 15% (wt.), in particular from 5 to 10% (wt.).

4. The single-layer or multilayer tubular food film that can be smoked, air-dried and peeled of claim 1, wherein the food film exhibits a film thickness in a range from 10 to 50 μm, preferably from 15 to 25 μm, preferably at a caliber of up to 90 mm, in particular at a caliber in a range from 15 to 40 mm.

5. The single-layer or multilayer tubular food film that can be smoked, air-dried and peeled of claim 1, wherein the food film exhibits a water vapor permeability of at least 0.5 kg/(m²·day), preferably in a range from 0.5 to 0.75 kg/(m²·day), at a film thickness of 20 μm.

6. The single-layer or multilayer tubular food film that can be smoked, air-dried and peeled of claim 1, wherein the food film exhibits an oxygen permeability of at least 4,000 cm³/(m²·day), preferably in a range from 4,000 to 6,000 cm³/(m²·day).

7. The single-layer or multilayer tubular food film that can be smoked, air-dried and peeled of claim 1, wherein the food film exhibits a modulus of elasticity of at least 3,000 N/mm², preferably in a range from 3,000 to 3.600 N/mm².

8. The single-layer or multilayer tubular food film that can be smoked, air-dried and peeled of claim 1, wherein the food film exhibits a—preferably automatic—peelability at a velocity of at least 0.4 m/s to 1.0 m/s, in particular of at least 0.5 m/s to 0.7 m/s.

9. The single-layer or multilayer tubular food film that can be smoked, air-dried and peeled of claim 1, wherein the plastic blend includes at least one silicate.

10. The single-layer or multilayer tubular food film that can be smoked, air-dried and peeled of claim 1, wherein the plastic blend includes at least one filler selected from a group consisting of corn starch, cellulose powder and micro glass beads.

11. The single-layer or multilayer tubular food film that can be smoked, air-dried and peeled of claim 1, wherein the plastic blend includes at least one filler selected from a group consisting of chalk, talcum, salts and other mineral substances.

12. A method for the manufacture of a single-layer or multilayer tubular food film that can be smoked, air-dried and peeled comprising,
manufacturing a homogeneous molten plastic material in a nozzle blast drawing process and under subsequent biaxial stretching in a triple-bubble process,
wherein
the molten plastic material is produced of
polystyrene or a blend of various polystyrenes, and
polyvinyl alcohol, and/or
polyether block amide.

13. The method of claim 12 wherein the plastic blend includes
a proportion of polystyrene or a blend of various polystyrenes from 20 to 98% (wt.),
a proportion of polyvinyl alcohol from 1 to 50% (wt.), and
a proportion of polyether block amide from 1 to 30% (wt.).

14. The method of claim 13, wherein,
a proportion of polystyrene or a blend of various polystyrenes from 55 to 90% (wt.), in particular from 60 to 75% (wt.),
a proportion of polyvinyl alcohol from 5 to 30% (wt.), in particular from 15 to 25% (wt.), and
a proportion of polyether block amide from 1 to 15% (wt.), in particular from 5 to 10% (wt.) is supplied.

15. The method of claim 12, wherein a film thickness of the food film is adjusted in a range from 10 to 50 μm, preferably from 15 to 25 μm, preferably at a caliber of up to 90 mm, in particular at a caliber in a range from 15 to 40 mm.

16. The method of claim 12, wherein the plastic blend is selected such that the food film exhibits a water vapor permeability of at least 0.5 kg/(m²·day), preferably in a range from 0.5 to 0.75 kg/(m²·day), at a film thickness of 20 μm.

17. The method according to claim 12, wherein the plastic blend is selected such that the food film exhibits an oxygen permeability of at least 4,000 cm3/(m²·day), preferably in a range from 4,000 to 6,000 cm3/(m²·day).

18. The according to claim 12, wherein the plastic blend is selected such that the food film exhibits a modulus of elasticity of at least 3,000 N/mm², preferably in a range from 3,000 to 3.600 N/mm².

19. The method of claim 12, wherein the plastic blend is selected such that the food film can be peeled, preferably in an automated manner, at a velocity of at least 0.4 m/s to 1.0 m/s, in particular of at least 0.5 m/s to 0.7 m/s.

20. The method according to claim 12, wherein at least one silicate is added to the plastic blend.

21. The method according to claim 12, wherein at least one filler selected from a group consisting of corn starch, cellulose powder and micro glass beads is added to the plastic blend.

22. The method according to claim 12, wherein at least one filler selected from a group consisting of chalk, talcum, salts and other mineral substances is added to the plastic blend.

23. The single-layer or multilayer tubular food film that can be smoked, air-dried and peeled of claim 1, wherein the plastic blend includes:
a proportion of polystyrene or a blend of various polystyrenes from 50 to 99% (wt.), and
a proportion of polyvinyl alcohol from 1 to 50% (wt.).

24. The single-layer or multilayer tubular food film that can be smoked, air-dried and of claim 1, wherein the plastic blend includes:
a proportion of polystyrene or a blend of various polystyrenes from 70 to 99% (wt.), and
a proportion of polyether block amide from 1 to 30% (wt.).

25. The single-layer or multilayer tubular food film that can be smoked, air-dried and peeled of claim 1, wherein the food film is a sausage casing for smoked and/or air-dried sausage or meat goods.

26. The method of claim 12, wherein the plastic blend includes
a proportion of polystyrene or a blend of various polystyrenes from 50 to 99% (wt.), and
a proportion of polyvinyl alcohol from 1 to 50% (wt.).

27. The method of claim 12, wherein the plastic blend includes
a proportion of polystyrene or a blend of various polystyrenes from 70 to 99% (wt.), and
a proportion of polyether block amide from 1 to 30% (wt.).

28. The method of claim 12, wherein the food film is a sausage casing.

29. The method of claim 12, further comprising filling the food film with sausage or meat goods prior to smoking and/or air drying.

30. A composition for manufacturing a tubular food film, said composition comprising a homogeneous molten plastic material, wherein said homogeneous molten plastic material comprises
polystyrene or a blend of various polystyrenes, and
polyvinyl alcohol, and/or
polyether block amide.
